(19) United States
(12) Patent Application Publication
(10) Pub. No.: US 2021/0302746 A1
(43) Pub. Date: Sep. 30, 2021

(54) OPTICAL SYSTEM, HEAD-MOUNTED DISPLAY DEVICE AND SMART GLASSES

(71) Applicant: GOERTEK TECHNOLOGY CO., LTD., Shandong (CN)

(72) Inventors: Zhenyu GAO, Shandong (CN); Bin JIANG, Shandong (CN)

(73) Assignee: GOERTEK TECHNOLOGY CO., LTD., Shandong (CN)

(21) Appl. No.: 17/250,361

(22) PCT Filed: Sep. 21, 2018
(86) PCT No.: PCT/CN2018/106924

§ 371 Date: Jan. 11, 2021

(30) Foreign Application Priority Data
Jul. 9, 2018 (CN) 201810747435.0

(51) Int. Cl. G02B 27/01; G02B 5/04; G02B 5/08

(52) U.S. Cl. CPC G02B 27/0172; G02B 2027/0178; G02B 5/08; G02B 5/04

(57) ABSTRACT

An optical system includes a reflecting-mirror group having a focal-power reflecting face and a free-form-surface-prism group. the latter includes an imaging prism. The focal-power reflecting face of the reflecting-mirror group is configured to reflect part of incident light ray to a first light entering face of the imaging prism. The first light entering face is configured to transmit part of the incident light ray to a second light entering face of the imaging prism. The second light entering face is configured to reflect part of light ray from the first light entering face to a third light entering face of the imaging prism. The third light entering face is configured to reflect part of light ray from the second light entering face to a light exiting face of the imaging prism. An intermediate imaging plane is formed in an optical path before the third light entering face.

### CROSS-REFERENCE TO RELATED APPLICATION

This application is a U.S. National-Stage entry under 35 U.S.C. § 371 based on International Application No. PCT/CN2018/106924, filed Sep. 21, 2018 which was published under PCT Article 21(2) and which claims priority to Chinese Application No. 201810747435.0, filed Jul. 9, 2018, which are all hereby incorporated herein in their entirety by reference.

### TECHNICAL FIELD

This application pertains to the technical field of augmented reality, and particularly relates to an optical system, a head-mounted displaying device and smart glasses.

### BACKGROUND

Optical systems are usually used for the clear imaging or the processing of optical information in imaging devices. With the rapid development of the AR (Augmented Reality) technique, head-mounted displaying devices based on the AR technique are increasingly extensively applied. In the head-mounted displaying devices, the virtual image displayed by the display is required to be amplified by an optical system, superposed with a realty image, and presented to a human eye. Because the head-mounted displaying devices are worn on the head of the user, in order to reduce the burden of the head of the user, compactness and light weight become demands in the designing of head-mounted displaying devices.

In conventional optical systems based on a free-form-surface prism, the light ray emitted by the display directly enters the free-form-surface prism, is refracted twice by the free-form-surface prism, and then transmitted to the human eye. However, because the light ray emitted by the display of the optical system is a scattered light, all of the light rays in the optical path that enters the human eye from the display exist in the form of a broad beam, which restricts the size of the view field of the system. In addition, other objects, desirable features and characteristics will become apparent from the subsequent summary and detailed description, and the appended claims, taken in conjunction with the accompanying drawings and this background.

### SUMMARY

Some embodiments of the present application provide an optical system, wherein the optical system comprises a reflecting-mirror group having a focal-power reflecting face and a free-form-surface-prism group, and the free-form-surface-prism group comprises an imaging prism;

the focal-power reflecting face of the reflecting-mirror group is configured to reflect at least part of incident light ray to a first light entering face of the imaging prism;

the first light entering face is configured to transmit at least part of the incident light ray to a second light entering face of the imaging prism;

the second light entering face is configured to reflect at least part of light ray from the first light entering face to a third light entering face of the imaging prism;

the third light entering face is configured to reflect at least part of light ray from the second light entering face to a light exiting face of the imaging prism; and

an intermediate imaging plane is formed in an optical path before the third light entering face.

In some embodiments, the reflecting-mirror group comprises a first polarized-reflection prism and a second polarized-reflection prism adhesively bonded to the first polarized-reflection prism, and the first polarized-reflection prism comprises a polarized-reflection face and a first focal-power reflecting face;

the incident light ray enters the first polarized-reflection prism via a light entering face of the first polarized-reflection prism;

at least part of the incident light ray is reflected by the polarized-reflection face to the first focal-power reflecting face of the first polarized-reflection prism; and

at least part of the incident light ray from the first focal-power reflecting face is reflected by the first focal-power reflecting face, is transmitted via the second polarized-reflection prism and then exits.

In some embodiments, the reflecting-mirror group comprises a curved-surface reflecting mirror having a second focal-power reflecting face.

In some embodiments, the optical system further comprises a projection-lens group formed by at least one lens; and

at least part of the incident light ray that has been reflected by the focal-power reflecting face of the reflecting-mirror group is transmitted via the projection-lens group and exits to the first light entering face of the imaging prism.

In some embodiments, the intermediate imaging plane is generated in an optical path between the projection-lens group and the imaging prism.

In some embodiments, a curvature in a horizontal direction and a curvature in a vertical direction of the third light entering face are different.

In some embodiments, the optical system further comprises a compensating prism adhesively bonded to the imaging prism;

the compensating prism is configured to receive an ambient light ray, and transmit at least part of the ambient light ray to the third light entering face of the imaging prism; and

at least part of the ambient light ray from the third light entering face exits via the light exiting face of the imaging prism.

In some embodiments, the second light entering face and the third light entering face are two opposite faces of the imaging prism; and

the compensating prism is adhesively bonded to the third light entering face.

In some embodiments, a first projection in a horizontal direction of at least part of the incident light ray along a horizontal edge view field from a human eye to the intermediate imaging plane and a second projection in the horizontal direction of at least part of the incident light ray along a horizontal central view field do not intersect.

Some embodiments of the present application provide a head-mounted displaying device, wherein the head-mounted displaying device comprises an optical system and a displaying system, wherein the optical system is of any one of the above optical system solutions; and

the displaying system is configured to generate the incident light ray.

In some embodiments, the displaying system comprises a first display, and the first display is arranged on one side of the reflecting-mirror group; or,

the displaying system comprises a second display and an illuminating assembly, and the illuminating assembly and the second display are arranged on two sides of the reflecting-mirror group, respectively; and

light that exits from the illuminating assembly is transmitted via the reflecting-mirror group and illuminates the second display to lighten the second display.

Some embodiments of the present application provide smart glasses, wherein the smart glasses comprise an optical system and a displaying system, wherein

the optical system is of any one of the above optical system solutions;

the displaying system is configured to generate the incident light ray;

the displaying system comprises a first display, and the first display is arranged on one side of the reflecting-mirror group; or,

the displaying system comprises a second display and an illuminating assembly, and the illuminating assembly and the second display are arranged on two sides of the reflecting-mirror group, respectively; and

light that exits from the illuminating assembly is transmitted via the reflecting-mirror group and illuminates the second display to lighten the second display.

Some embodiments of the present application provide an optical system, a head-mounted displaying device and smart glasses. The optical system comprises a reflecting-mirror group having a focal-power reflecting face and a free-form-surface-prism group, and the free-form-surface-prism group comprises an imaging prism. The focal-power reflecting face of the reflecting-mirror group is configured to reflect at least part of incident light ray to a first light entering face of the imaging prism. The first light entering face is configured to transmit at least part of the incident light ray to a second light entering face of the imaging prism. The second light entering face is configured to reflect at least part of light ray from the first light entering face to a third light entering face of the imaging prism. The third light entering face is configured to reflect at least part of light ray from the second light entering face to a light exiting face of the imaging prism. An intermediate imaging plane is formed in an optical path before the third light entering face. Some embodiments of the present application realize secondary imaging of at least part of the incident light ray in the optical path entering the human eye by using the optical system, and enable the at least part of the incident light ray in the form of a broad beam to converge by the intermediate imaging, which prevents the restriction of the system on the view field by the broad beam, and further increases the field angle of the system.

### BRIEF DESCRIPTION OF THE DRAWINGS

The present invention will hereinafter be described in conjunction with the following drawing figures, wherein like numerals denote like elements, and:

FIG. 1 shows a schematic structural diagram of the optical system according to some embodiments of the present application;

FIG. 2 shows a top schematic structural diagram from a human eye to the free-form-surface-prism group of the optical system according to some embodiments of the present application;

FIG. 3 shows a schematic structural diagram of the optical system according to another some embodiments of the present application;

FIG. 4 shows a schematic structural diagram of the optical system according to still another some embodiments of the present application;

FIG. 5(a) to FIG. 5(c) show schematic structural diagrams of an embodiment of the head-mounted displaying device according to some embodiments of the present application; and

FIG. 6(a) to FIG. 6(c) show schematic structural diagrams of an embodiment of the smart glasses according to some embodiments of the present application.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The technical solutions of the embodiments of the present application will be described below with reference to the drawings of the embodiments of the present application. Apparently, the described embodiments are merely certain embodiments of the present application, rather than all of the embodiments. All of the other embodiments that a person skilled in the art obtains on the basis of the embodiments of the present application without paying creative work fall within the protection scope of the present application.

The optical system according to some embodiments of the present application can be applied to the technical fields of the current virtual reality, augmented reality, medical imaging and so on, and is suitable for, but not limited to, head-mounted displaying devices or smart glasses, wherein the head-mounted displaying devices or smart glasses may include a VR (Virtual Reality) device, an AR (Augmented Reality) device, an MR (Mixed Reality) device and so on.

Some embodiments of the present application provide an optical system, a head-mounted displaying device and smart glasses. The optical system comprises a reflecting-mirror group having a focal-power reflecting face and a free-form-surface-prism group, and the free-form-surface-prism group comprises an imaging prism. The focal-power reflecting face of the reflecting-mirror group is configured to reflect at least part of incident light ray to a first light entering face of the imaging prism. The first light entering face is configured to transmit at least part of the incident light ray to a second light entering face of the imaging prism. The second light entering face is configured to reflect at least part of light ray from the first light entering face to a third light entering face of the imaging prism. The third light entering face is configured to reflect at least part of light ray from the second light entering face to a light exiting face of the imaging prism. An intermediate imaging plane is formed in an optical path before the third light entering face. Some embodiments of the present application realize secondary imaging of at least part of the incident light ray in the optical path entering the human eye by using the optical system, and enable the at least part of the incident light ray in the form of a broad beam to converge by the intermediate imaging, which prevents the restriction of the system on the view field by the broad beam, and further increases the field angle of the system.

The technical solutions of the present application will be described in detail below with reference to the drawings.

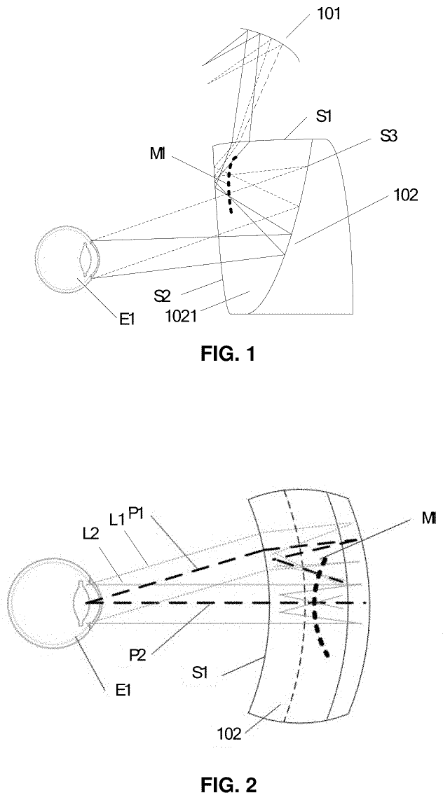

FIG. 1 is a schematic structural diagram of an embodiment of the optical system according to some embodiments of the present application. The system may comprise a reflecting-mirror group 101 having a focal-power reflecting face and a free-form-surface-prism group 102. The free-form-surface-prism group comprises an imaging prism 1021.

In practical applications, the optical system may be applied to, but not limited to, head-mounted displaying devices or smart glasses, and is especially suitable for head-mounted displaying devices for VR or AR imaging. The display of the head-mounted displaying devices or smart glasses may be a backlight LCOS (Liquid Crystal On Silicon) display, an LCD (Liquid Crystal Display), a Micro-OLED (Organic Light-Emitting Diode) or another miniaturized display.

The focal-power reflecting face of the reflecting-mirror group 101 is configured to reflect at least part of incident light ray to a first light entering face S1 of the imaging prism 1021.

In some embodiments, the reflecting-mirror group 101 folds and converges at least part of the incident light ray by using the focal-power reflecting face, thereby converging at least part of the incident light ray that exists in the form of a broad beam, which greatly reduces the area of the optically effective face that is occupied by the light beam in the propagation within the system. On the basis of that, in the designing of the optical system, the size of the free-form-surface prisms 102 of the system can be reduced, or, while maintaining the size of the free-form-surface prisms of the system constant, the view field of the system is increased, which reduces the restriction on the system size and the system view field by the broad beam.

In practical applications, the reflecting-mirror group 101 may comprise at least one reflecting mirror and at least one reflecting face having a focal power. The face types of the optical faces of the reflecting-mirror group 101 may be, according to the practical demands of design, a planar face, a spherical face, an aspherical face or a free-form surface, which is not particularly limited here.

The first light entering face S1 of the imaging prism 1021 is configured to transmit at least part of the incident light ray to the second light entering face S2 of the imaging prism 1021. In practical applications, the free-form-surface prisms 102 are used to solve the contradictory of the optical system among the field angle, the distance of exit pupil and the miniaturization and light weighting, to obtain an optical system having a large field angle, a short distance of exit pupil and small size and weight.

In the prior art, at least part of the incident light ray generated by a display is directly transmitted into a free-form-surface prism, is reflected twice in the free-form-surface prism, and then enters the human eye, and the area on the surface of the free-form-surface prism that is illuminated by the light ray is the optically effective face. Because the incident light ray generated by the display is in the form of a broad beam, which restricts the view field of the system, the angle of incidence of the entering of the incident light ray to the free-form-surface prism may be adjusted to increase the field angle, by adjusting the back focal lengths of the display and the free-form-surface prism. However, while increasing the field angle, that restricts the back focal lengths of the display and the free-form-surface prism, which results in that the back focal lengths are too small. For displays that require to occupy a certain space, that results in a greatly increased difficulty in the designing of the structure of the system.

Some embodiments of the present application, by introducing the reflecting-mirror group, can enable at least part of the incident light ray generated by the display to be reflected by the reflecting-mirror group, to enable the at least part of the incident light ray to enter the free-form-surface-prism group via the first light entering face S1 of the imaging prism, which reduces the restriction on the back focal length of the system. Furthermore, the focal-power reflecting face of the reflecting-mirror group converges the incident light ray emitted by the display in the form of a broad beam, to greatly reduce the width of the light beam of at least part of the incident light ray, which further reduces the restriction on the field angle of the system by the size of the free-form-surface prisms, can obtain a larger field angle while ensuring a certain back focal length, and in turn greatly reduces the difficulty in the designing of the structure of the system.

The second light entering face S2 of the imaging prism 1021 is configured to reflect at least part of the light ray from the first light entering face S1 to the third light entering face S3 of the imaging prism.

The third light entering face S3 is configured to reflect at least part of the light ray from the second light entering face S2 to the light exiting face S2 of the imaging prism. In the present embodiment, in the free-form-surface-prism group 102 the second light entering face and the light exiting face of the imaging prism 1021 are the same face, but occupy different optically effective faces.

An intermediate imaging plane M1 is formed in the optical path before the third light entering face S3. At least part of the incident light ray is converged via the focal-power reflecting face, whereby it is converged in the optical path from the focal-power reflecting face to the third light entering face to form the intermediate imaging plane M1. The light exiting face of the imaging prism 1021 transmits at least part of the light ray from the third light entering face S3 to the human eye E1 for imaging.

In practical applications, according to the variation of the actual focal length of the focal-power reflecting face, the formation of the intermediate imaging plane by the converging of at least part of the incident light ray via the focal-power reflecting face may be at any position in the first optical path of the at least part of the incident light ray from the reflection by the focal-power reflecting face to the first light entering face of the imaging prism 1021, in the second optical path of the transmission from the first light entering face to the second light entering face or in the third optical path of the reflection from the second light entering face to the third light entering face. The optical system can enable the incident light ray to generate the intermediate imaging plane in the propagation in the system, to realize secondary imaging of the system. Furthermore, such an optical path that can realize the secondary imaging of the system can not only increase the field angle of the system and reduce the area of the optically effective face of the system, but can also increase the back focal length of the system.

In order to further reduce the difficulty in the designing of the structure of the system, the optical path in the optical system may also satisfy the following conditions. FIG. 2 shows a top schematic structural diagram of the optical system. As seen in the direction from the human eye to the generation of the incident light ray, the imaging optical path in the system from the human eye to the generation of the incident light ray is formed by sequentially at least part of the incident light ray from the human eye to the light exiting face S2, at least part of the incident light ray from the light exiting face to the third light entering face, at least part of the incident light ray from the third light entering face to the second light entering face, at least part of the incident light ray from the second light entering face to the first light entering face, at least part of the incident light ray from the first light entering face to the focal-power reflecting face and at least part of the incident light ray that enters the imaging-prism group. The at least part of the incident light ray that enters any point of the human eye may be divided into an imaging light ray L1 along a horizontal edge view field and an imaging light ray L2 along a horizontal central view field.

In some embodiments, a first projection in a horizontal direction of at least part of the incident light ray along a horizontal edge view field from a human eye to the intermediate imaging plane and a second projection in the horizontal direction of at least part of the incident light ray along a horizontal central view field do not intersect.

In other words, the marginal light ray P1 and the central light ray P2 do not intersect in the imaging optical path of the light-ray propagation from the human eye to the intermediate imaging plane, thereby further reducing the focal power of the part of the optical path from the human eye E1 to the intermediate imaging plane M1, and improving the imaging quality in the human eye. Therefore, it is not required to provide a focal-power modulating and compensating module while ensuring the imaging quality, thereby further reducing the difficulty in the designing of the structure of the system. Therefore, the optical system has the characteristics of a small size, a large view field and a high imaging quality, and is suitable for compact head-mounted displaying devices.

In the optical system according to some embodiments of the present application, the focal-power reflecting face of the reflecting-mirror group 101 focuses at least part of the incident light ray, which is then modulated by the free-form-surface-prism group 102 of the system, whereby at least part of the incident light ray forms the intermediate imaging plane in the system. The system realizes a particular secondary imaging optical path by regulating the optical elements, which solves the technical problem that the propagation of a broad beam in the system results in a limited field angle of the system. Moreover, the increasing of the view field of the system reduces the restriction on the back focal length of the system, and reduces the difficulty in the designing of the structure of the optical system.

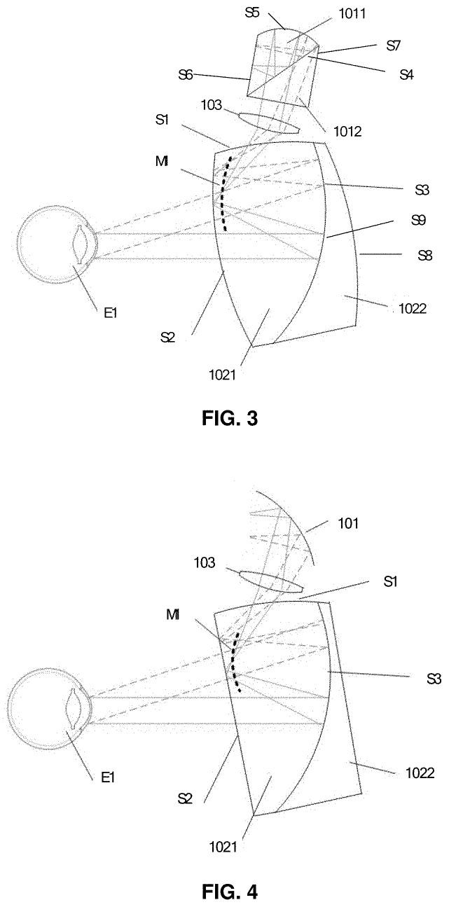

FIG. 3 is a schematic structural diagram of another embodiment of the optical system according to some embodiments of the present application. The system comprises, besides the reflecting-mirror group 101 and the free-form-surface-prism group 102 of the embodiment in FIG. 1, a projection-lens group 103 formed by at least one lens. The reflecting-mirror group 101 may comprise a first polarized-reflection prism 1011 and a second polarized-reflection prism 1012 adhesively bonded to the first polarized-reflection prism 1011. The first polarized-reflection prism 1011 comprises a polarized-reflection face S4 and a first focal-power reflecting face S5.

Some embodiments according to the present application are applicable to the above-described displays that require independent light supply such as an LCOS display or displays that do not require independent light supply such as an LCD display and an OLED display.

The incident light ray enters the first polarized-reflection prism 1011 via the light entering face S6 of the first polarized-reflection prism 1011.

At least part of the incident light ray is reflected by the polarized-reflection face S4 to the first focal-power reflecting face S5 of the first polarized-reflection prism 1011.

At least part of the incident light ray from the first focal-power reflecting face S5 is reflected by the first focal-power reflecting face S5, is transmitted via the second polarized-reflection prism 1012 and then exits.

The polarized-reflection face S4 polarizes and splits the incident light ray, reflects the incident light ray having a certain polarization direction, transmits the incident light ray having the other polarization direction, thereby polarizing and splitting the incident light ray and reserving merely the incident light ray having one polarization direction to enter the free-form-surface-prism group 102.

In practical applications, the optical faces of the reflecting-mirror group 101, such as the polarized-reflection face S4, the focal-power reflecting face S5 and the light entering face S6, may be, according to the demands, a planar face, a spherical face, an aspherical face or a free-form surface. Moreover, the reflecting-mirror group 101 can also realize rectifying the aberration in the system and converting the light rays in the different view fields, to realize the function of the projection-lens group 103. In this case, the system can eliminate the projection-lens group 103.

In practical applications, when the reflecting-mirror group 101 cannot realize the function of the projection-lens group, the optical system may also comprise a projection-lens group 103 formed by at least one lens. The projection-lens group 103 may be arranged between the reflecting-mirror group 101 and the free-form-surface-prism group 102. In some embodiments, at least part of the incident light ray that has been reflected by the focal-power reflecting face of the reflecting-mirror group 101 is transmitted via the projection-lens group 103 and exits to the first light entering face S1 of the imaging prism 1021.

The projection-lens group 103 is configured to rectify the aberration in the system and convert the light rays in the different view fields, and the face types of its lenses may be a spherical face, an aspherical face, a Fresnel face, a free-form surface and so on, which is not particularly limited here.

In some embodiments, the free-form-surface-prism group 102 may also comprise a compensating prism 1022 adhesively bonded to the imaging prism 1021.

The compensating prism 1022 is configured to receive the environmental light ray emitted by the real scene in the three-dimensional space and transmit at least part of the environmental light ray to the third light entering face S3 of the imaging prism 1021. At least part of the ambient light ray from the third light entering face S3 exits via the light exiting face S2 of the imaging prism 1021.

In some embodiments, the second light entering face S2 and the third light entering face S3 are two opposite faces of the imaging prism 1021. Furthermore, the compensating prism 1022 is adhesively bonded to the third light entering face S3 of the imaging prism 1021.

The light exiting face S2 of the imaging prism transmits at least part of the environmental light ray to the human eye E1, to fuse the virtual image to be displayed and the real scene for imaging.

The compensating prism 1022 is used to compensate the affection on the refraction of the light ray emitted by the real scene by the imaging prism, reduce the distortion of the imaging and improve the imaging quality. The compensating prism 1022 may comprise a light entering face S8 and a light exiting face S9. The third light entering face S3 of the imaging prism is adhesively bonded to the light exiting face S9 of the compensating prism, whereby the imaging prism 1021 and the compensating prism 1022 form the free-form-surface-prism group 102. The environmental light ray emitted by the real scene in the three-dimensional space is firstly transmitted via the light entering face S8 of the compensating prism 1022, enters the compensating prism and then reaches the light exiting face S9 of the compensating prism. The light exiting face S9 of the compensating prism 1022 transmits the at least part of the environmental light ray to the third light entering face S3 of the imaging prism 1021, and then the third light entering face S3 transmits to the light exiting face S2 of the imaging prism 1021.

The light exiting face S2 of the imaging prism 1021 transmits the environmental light ray for generating the real scene and at least part of the incident light ray for generating the image to be displayed to the human eye, so that the image to be displayed and the real scene fuse into an image in the human eye, thereby obtaining an AR image which combines the virtual world and the real world.

The second light entering face S2 of the imaging prism 1021 may be, according to the demands, a planar face, a concave face or a convex face, and the reflection on it may be total reflection or surface-coated reflection. The surface-coated reflection is suitable merely when the effective areas on the second optically effective face S2 occupied by the second light ray and the third light ray do not overlap.

In some embodiments, the face types of the optical faces of the imaging prism 1021 and the compensating prism 1022 of the free-form-surface prisms 102 may be a planar face, a spherical face, an aspherical face or a free-form surface. The third light entering face S3 is a free-form surface having different curvatures in the horizontal direction and the vertical direction.

In some embodiments of the present application, the system applies the principle of refracted and reflected imaging of free-form-surface prisms, and generates the intermediate imaging plane M1 in the optical path between the projection-lens group 103 and the imaging prism 1021, to realize secondary imaging of the system, which can greatly increase the field angle of the system, reduce the size of the system and improve the imaging quality.

FIG. 4 is a schematic structural diagram of still another embodiment of the optical system according to some embodiments of the present application. The system comprises, besides the reflecting-mirror group 101 and the free-form-surface-prism group 102 of the embodiment in FIG. 1, a projection-lens group 103 formed by at least one lens. The reflecting-mirror group 101 comprises a curved-surface reflecting mirror having a second focal-power reflecting face.

The projection-lens group 103 may be arranged between a curved-surface reflecting mirror and the free-form-surface-prism group 102, for rectifying the aberration of the system and controlling the light angles of different view fields.

The optical system according to the present embodiment is suitable for displays that do not require independent light supply, such as an LCD display and an OLED display.

The second focal-power reflecting face of the curved-surface reflecting mirror is used to reflect at least part of the incident light ray, so that the at least part of the incident light ray is transmitted via the projection-lens group 103 and then exits to the first light entering face S1 of the imaging prism 1021.

In the present embodiment, its difference from the embodiment in FIG. 3 is the first optical path in which the curved-surface reflecting mirror replaces the polarized-reflection prism group, and the curved-surface reflecting mirror reflects at least part of the incident light ray, so that the at least part of the incident light ray is transmitted via the projection-lens group 103 and exits to the first light entering face S1 of the imaging prism 1021. the second optical path that transmits from the first light entering face S1 to the second light entering face S2 and the third optical path that reflects from the second light entering face S2 to the third light entering face S3 are the same as those of the embodiment in FIG. 3, have already been in detail described above, and are not discussed here further.

Likewise, the free-form-surface-prism group 102 and the projection-lens group 103 according to the present embodiment have already been in detail described in the embodiment in FIG. 3, and are not discussed here further.

In the optical systems according to the embodiment in FIG. 1, the embodiment in FIG. 3 and the embodiment in FIG. 4 of the present application, all of the shapes, the sizes and the reflection modes of the optical faces of the optical elements in the system such as the reflecting-mirror group 101, the free-form-surface-prism group 102 and the projection-lens group 103 are not particularly limited. The combinations of the sizes, the positions and the shapes of the optical elements in the above optical systems can realize the generation of the intermediate imaging plane in the imaging light path from the display to the human eye, and the intermediate imaging plane may be generated at any position in the optical path between the projection-lens group and the imaging prism, which is not particularly limited here. Moreover, the optical system according to the embodiments of the present application can also realize that, in the light path from the human eye to the intermediate imaging plane, the marginal light ray and the horizontal light ray do not intersect in the propagation, which increases the field angle of the system and satisfies the demand of the system on a high imaging quality, thereby realizing augmented-reality imaging with a large view field and a high quality.

In conclusion, the optical system according to some embodiments of the present application has the advantages of a small size, a large view field and a high imaging quality, which overcomes the restriction on the system size and the system view field by the propagation of a broad beam in the prior art, and further reduces the difficulty in the designing of the structure of the system.

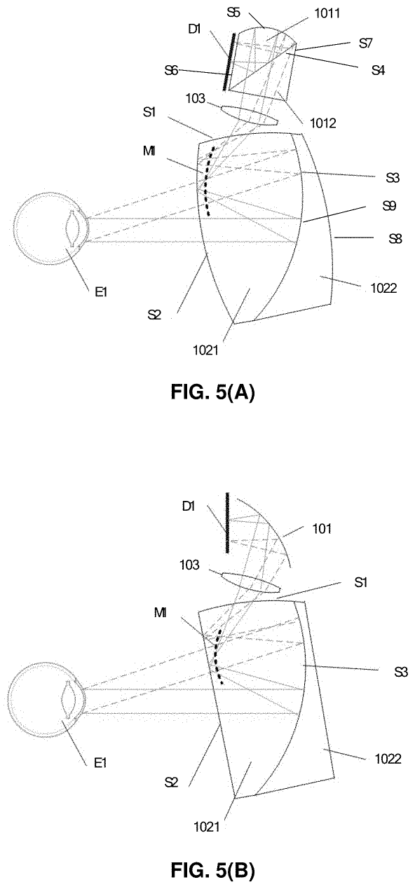

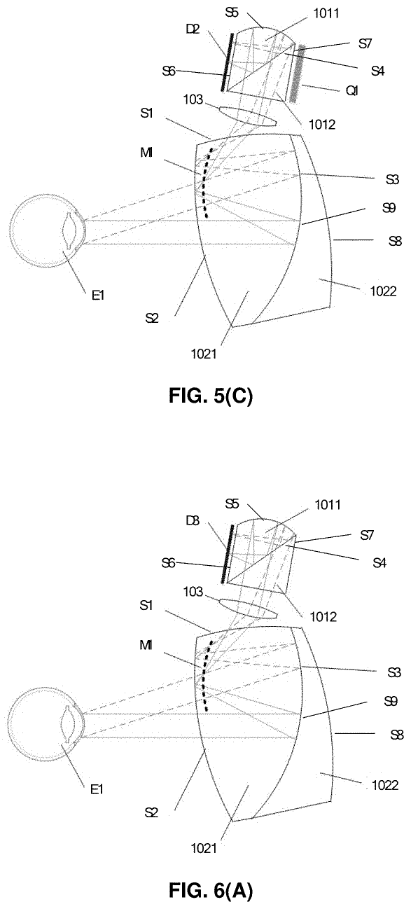

FIG. 5(a) to FIG. 5(c) are schematic structural diagrams of an embodiment of the head-mounted displaying device according to some embodiments of the present application. The head-mounted displaying device comprises an optical system and a displaying system, wherein the optical system is the optical system of the embodiments in FIGS. 1-4.

The displaying system is configured to generate the incident light ray.

The head-mounted displaying device may be a head-mounted displaying device based on VR or a head-mounted displaying device based on AR, which is not particularly limited here.

In some embodiments, the displaying system may comprise a first display D1, and the first display D1 is arranged on one side of the reflecting-mirror group 101.

As shown in FIG. 5(a), the first display may be arranged on the one side adjacent to the light entering face S6 of the first polarized-reflection prism 1011, or, as shown in FIG. 5(b), arranged on the one side adjacent to the second focal-power reflecting face of the curved-surface reflecting-mirror group.

The first display may be an LCD display, an OLED display and so on, and is used to generate the incident light ray.

In some embodiments, as shown in FIG. 5(c), the displaying system comprises a second display D2 and an illuminating assembly Q1, and the illuminating assembly Q1 and the second display D2 are arranged on two sides of the reflecting-mirror group 101, respectively.

The illuminating assembly may be an illuminating assembly of an arbitrary shape formed by one or more LEDs, and may also be an illuminating assembly formed by other illuminating devices for illuminating, which is not particularly limited here.

Light that exits from the illuminating assembly Q1 is transmitted via the reflecting-mirror group 101 and illuminates the second display D2 to lighten the second display D2.

The second display is a display based on a reflection mode; for example, it may be an LCOS display. Therefore, it cannot independently emit light, and, therefore, it is required to independently supply light to the second display. The illuminating assembly emitting natural light may be used to illuminate the second display with the generated natural light, to lighten the second display based on the reflection principle of the second display D2, thereby generating the incident light ray.

The second display D2 may be arranged on the one side adjacent to the light entering face S6 of the first polarized-reflection prism 1011, and the illuminating assembly Q1 is arranged on one side adjacent to the light entering face S7 of the second polarized-reflection prism 1012. The light entering face S6 of the first polarized-reflection prism 1011 and the light entering face S7 of the second polarized-reflection prism 1012 are arranged oppositely.

The light entering face S7 of the second polarized-reflection prism 1012 is configured to transmit at least part of the natural light ray generated by the illuminating assembly Q1 to the polarized-reflection face S4 of the first polarized-reflection prism 1011. At least part of the natural light ray from the polarized-reflection face S4 is transmitted via the light entering face S6 of the first polarized-reflection prism to the second display D2 and lightens the second display D2, to cause the second display D2 to generate the incident light ray.

The present embodiment seeks to protect a head-mounted displaying device, wherein the head-mounted displaying device comprises the structure of the above-described optical system and the structure of the above-described displaying system, and can further reduce the volume and the weight of the head-mounted displaying device, to obtain a head-mounted displaying device that is more compact and has a lighter weight.

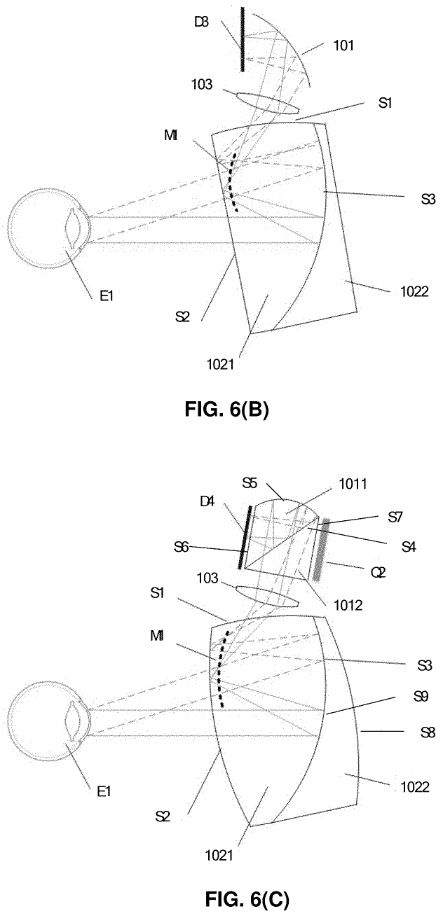

FIG. 6(a) to FIG. 6(c) are schematic structural diagrams of an embodiment of the smart glasses according to some embodiments of the present application. The smart glasses comprise an optical system and a displaying system. The optical system is the optical system of the embodiments in FIGS. 1-4.

The displaying system is configured to generate the incident light ray.

The smart glasses may be smart glasses based on VR or smart glasses based on AR, which is not particularly limited here.

In some embodiments, the displaying system may comprise a first display D3, and the first display D3 is arranged on one side of the reflecting-mirror group 101.

As shown in FIG. 6(a), the first display D3 may be arranged on the one side adjacent to the light entering face S6 of the first polarized-reflection prism 1011, or, as shown in FIG. 6(b), arranged on the one side adjacent to the second focal-power reflecting face of the curved-surface reflecting-mirror group.

The first display D3 may be an LCD display, an OLED display and so on, and is used to generate the incident light ray.

In some embodiments, as shown in FIG. 6(c), the displaying system comprises a second display D4 and an illuminating assembly Q2, and the illuminating assembly Q2 and the second display D4 are arranged on two sides of the reflecting-mirror group 101, respectively.

The illuminating assembly may be an illuminating assembly of an arbitrary shape formed by one or more LEDs, and may also be an illuminating assembly formed by other illuminating devices for illuminating, which is not particularly limited here.

Light that exits from the illuminating assembly Q2 is transmitted via the reflecting-mirror group 101 and illuminates the second display D4 to lighten the second display D4.

The second display is a display based on a reflection mode; for example, it may be an LCOS display. Therefore, it cannot independently emit light, and, therefore, it is required to independently supply light to the second display. The illuminating assembly emitting natural light may be used to illuminate the second display with the generated natural light, to lighten the second display based on the reflection principle of the second display D4, thereby generating the incident light ray.

The second display D4 may be arranged on the one side adjacent to the light entering face S6 of the first polarized-reflection prism 1011, and the illuminating assembly Q2 is arranged on one side adjacent to the light entering face S7 of the second polarized-reflection prism 1012. The light entering face S6 of the first polarized-reflection prism 1011 and the light entering face S7 of the second polarized-reflection prism 1012 are arranged oppositely.

The light entering face S7 of the second polarized-reflection prism 1012 is configured to transmit at least part of the natural light ray generated by the illuminating assembly Q2 to the polarized-reflection face S4 of the first polarized-reflection prism 1011. At least part of the natural light ray from the polarized-reflection face S4 is transmitted via the light entering face S6 of the first polarized-reflection prism to the second display D4 and lightens the second display D4, to cause the second display D4 to generate the incident light ray.

The present embodiment seeks to protect smart glasses, wherein the smart glasses comprise the structure of the above-described optical system and the structure of the above-described displaying system, and can further reduce the volume and the weight of the smart glasses, to obtain smart glasses that are more compact and have a lighter weight.

The embodiments in the description are described in the mode of paralleling or progression, each of the embodiments emphatically describes the differences from the other embodiments, and the same or similar parts of the embodiments may refer to each other. Regarding the devices disclosed by the embodiments, because they correspond to the methods disclosed by the embodiments, they are described simply, and the relevant parts may refer to the description on the methods.

A person skilled in the art can also understand that the units and the algorithm steps of the examples described by referring to the embodiments disclosed herein may be implemented by using electronic hardware, a computer software or a combination thereof. In order to clearly explain the interchangeability between the hardware and the software, the above description has described generally the configurations and the steps of the examples according to the functions. Whether those functions are executed by hardware or software depends on the particular applications and the design constraints of the technical solutions. A person skilled in the art may employ different methods to implement the described functions with respect to each of the particular applications, but the implementations should not be considered as extending beyond the scope of the present application.

The steps of the method or algorithm described by referring to the embodiments disclosed herein may be implemented directly by using hardware, a software module executed by a processor or a combination thereof. The software module may be embedded in a random access memory (RAM), an internal storage, a read-only memory (ROM), an electrically programmable ROM, an electrically erasable programmable ROM, a register, a hard disk, a removable disk, a CD-ROM, or a storage medium in any other form well known in the art.

It should also be noted that, in the present text, relation terms such as first and second are merely used to distinguish one entity or operation from another entity or operation, and that does not necessarily require or imply that those entities or operations have therebetween any such actual relation or order. Furthermore, the terms “include”, “comprise” or any variants thereof are intended to cover non-exclusive inclusions, so that processes, methods, articles or devices that include a series of elements do not only include those elements, but also include other elements that are not explicitly listed, or include the elements that are inherent of such processes, methods, articles or devices. Unless further limitation is set forth, an element defined by the wording “comprising a . . . ” does not exclude additional the same element in the process, method, article or device comprising the element.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. An optical system, wherein the optical system comprises a reflecting-mirror group having a focal-power reflecting face and a free-form-surface-prism group, and the free-form-surface-prism group comprises an imaging prism;
the focal-power reflecting face of the reflecting-mirror group is configured to reflect at least part of incident light ray to a first light entering face of the imaging prism;
the first light entering face is configured to transmit at least part of the incident light ray to a second light entering face of the imaging prism;
the second light entering face is configured to reflect at least part of light ray from the first light entering face to a third light entering face of the imaging prism;
the third light entering face is configured to reflect at least part of light ray from the second light entering face to a light exiting face of the imaging prism; and
an intermediate imaging plane is formed in an optical path before the third light entering face.

2. The optical system according to claim 1, wherein the reflecting-mirror group comprises a first polarized-reflection prism and a second polarized-reflection prism adhesively bonded to the first polarized-reflection prism, and the first polarized-reflection prism comprises a polarized-reflection face and a first focal-power reflecting face;
the incident light ray enters the first polarized-reflection prism via a light entering face of the first polarized-reflection prism;
at least part of the incident light ray is reflected by the polarized-reflection face to the first focal-power reflecting face of the first polarized-reflection prism; and
at least part of the incident light ray from the first focal-power reflecting face is reflected by the first focal-power reflecting face, is transmitted via the second polarized-reflection prism and then exits.

3. The optical system according to claim 1, wherein the reflecting-mirror group comprises a curved-surface reflecting mirror having a second focal-power reflecting face.

4. The optical system according to claim 1, wherein the optical system further comprises a projection-lens group formed by at least one lens; and
at least part of the incident light ray that has been reflected by the focal-power reflecting face of the reflecting-mirror group is transmitted via the projection-lens group and exits to the first light entering face of the imaging prism.

5. The optical system according to claim 4, wherein the intermediate imaging plane is generated in an optical path between the projection-lens group and the imaging prism.

6. The optical system according to claim 1, wherein a curvature in a horizontal direction and a curvature in a vertical direction of the third light entering face are different.

7. The optical system according to claim 1, wherein the optical system further comprises a compensating prism adhesively bonded to the imaging prism;
the compensating prism is configured to receive an ambient light ray, and transmit at least part of the ambient light ray to the third light entering face of the imaging prism; and
at least part of the ambient light ray from the third light entering face exits via the light exiting face of the imaging prism.

8. The optical system according to claim 7, wherein
the second light entering face and the third light entering face are two opposite faces of the imaging prism; and
the compensating prism is adhesively bonded to the third light entering face.

9. The optical system according to claim 1, wherein
a first projection in a horizontal direction of at least part of the incident light ray along a horizontal edge view field from a human eye to the intermediate imaging plane and a second projection in the horizontal direction of at least part of the incident light ray along a horizontal central view field do not intersect.

10. A head-mounted displaying device, wherein the head-mounted displaying device comprises an optical system and a displaying system, wherein the optical system comprises:
a reflecting-mirror group having a focal-power reflecting face and a free-form-surface-prism group, and the free-form-surface-prism group comprises an imaging prism;
the focal-power reflecting face of the reflecting-mirror group is configured to reflect at least part of incident light ray to a first light entering face of the imaging prism;
the first light entering face is configured to transmit at least part of the incident light ray to a second light entering face of the imaging prism;
the second light entering face is configured to reflect at least part of light ray from the first light entering face to a third light entering face of the imaging prism;
the third light entering face is configured to reflect at least part of light ray from the second light entering face to a light exiting face of the imaging prism; and
an intermediate imaging plane is formed in an optical path before the third light entering face; and
the displaying system is configured to generate the incident light ray.

11. The head-mounted displaying device according to claim 10, wherein
the displaying system comprises a first display, and the first display is arranged on one side of the reflecting-mirror group; or,
the displaying system comprises a second display and an illuminating assembly, and the illuminating assembly and the second display are arranged on two sides of the reflecting-mirror group, respectively; and
light that exits from the illuminating assembly is transmitted via the reflecting-mirror group and then illuminates the second display to lighten the second display.

12. Smart glasses, wherein the smart glasses comprise an optical system and a displaying system, wherein
the optical system is the optical system according to claim 7;
the displaying system is configured to generate the incident light ray;
the displaying system comprises a first display, and the first display is arranged on one side of the reflecting-mirror group; or,
the displaying system comprises a second display and an illuminating assembly, and the illuminating assembly and the second display are arranged on two sides of the reflecting-mirror group, respectively; and
light that exits from the illuminating assembly is transmitted via the reflecting-mirror group and then illuminates the second display to lighten the second display.

13. Smart glasses, wherein the smart glasses comprise an optical system and a displaying system, wherein
the optical system is the optical system according to claim 8;
the displaying system is configured to generate the incident light ray;
the displaying system comprises a first display, and the first display is arranged on one side of the reflecting-mirror group; or,
the displaying system comprises a second display and an illuminating assembly, and the illuminating assembly and the second display are arranged on two sides of the reflecting-mirror group, respectively; and
light that exits from the illuminating assembly is transmitted via the reflecting-mirror group and then illuminates the second display to lighten the second display.
